(19) United States
(12) Patent Application Publication
(10) Pub. No.: US 2010/0220259 A1
(43) Pub. Date: Sep. 2, 2010

(54) ILLUMINATION DEVICE AND LIQUID CRYSTAL DISPLAY DEVICE

(76) Inventors: Kazuaki Ohkubo, Osaka (JP); Kiyoshi Hashimotodani, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/064,774

(22) PCT Filed: Sep. 20, 2007
(86) PCT No.: PCT/JP2007/068241

§ 371 Date: Feb. 25, 2008

(30) Foreign Application Priority Data
Nov. 14, 2006 (JP) 2006-307796

(51) Int. Cl. G02F 1/1335; H05B 41/24

(52) U.S. Cl. 349/62; 315/250

(57) ABSTRACT

A backlight device 21 is an illumination device having a plurality of internal-external electrode type dielectric barrier discharge lamps. The backlight device 21 has a plurality of internal electrodes respectively arranged inside each of bulb 32 and connected in parallel to a lighting circuit 40 for outputting an AC driving voltage, and an external electrode arranged outside each of the bulbs 32 with a gap 41 and grounded. Holding members 43A to 43C holds the bulbs 32 so that distances between the bulbs 32 and the external electrode 36 are regularly varied seen from a direction of the axial line of the bulb 32.

### TECHNICAL FIELD

The present invention relates to an illumination device such as a backlight device for illuminating a liquid crystal display device, an illumination device for illuminating an original in apparatuses including a facsimile machine and copier, or general illumination device. Further, the present invention relates to a liquid crystal display device provided with such an illumination deice as a backlight device.

Recently, researches on lamps not using mercury (hereinbelow referred to as mercury-free type) as a lamp (or light source devices) for light source device such as a back light device of a liquid crystal display device is actively progressing, in addition to researches on lamps using mercury for such usage. The mercury-free type lamps are preferable due to low fluctuation of light emission intensity along with time variation of temperature and in view of consideration of environments.

One of known mercury-free lamps is a so-called an internal-external electrode type dielectric barrier discharge lamp that has a tubular bulb in which a rare gas is sealed, an internal electrode disposed inside the bulb, and an external electrode disposed outside the bulb. Application of a voltage between the internal electrode and external electrode causes a dielectric barrier discharge, resulting in that the rare gas is plasmanized to emit light.

Various external electrode shapes are known. For example, Patent Document 1 discloses an internal-external electrode type dielectric barrier discharge lamp (hereinafter merely referred to as “lamp”) 1 shown in FIG. 15 and FIG. 16 having an external electrode 2 of a strip shape with constant width. A reference numeral 3 denotes an internal electrode and a reference numeral 4 denotes a lighting circuit. A gap is provided between the external electrode 2 and an outer peripheral surface of the straight-tube shape bulb 5 by a spacer 6. A certain size of the gap achieves stable light emission of the lamp 1 and prevention of dielectric breakdown of an atmospheric gas filled in the gap, resulting in that damage to peripheral members by gas molecules ionized due to dielectric breakdown can be prevented. In this construction, the certain size of the gap remarkably decreases a ratio of the light reflected by the external electrode 2 and returning into the bulb 5 with respect to total amount of light emitted from the bulb 5. In other words, by disposing the external electrode 2 with the gap to the bulb 5, light emitted from the bulb 5 can be effectively reflected by a surface of the external electrode 2 and efficiently extracted outside the lamp 1.

FIGS. 17 and 18 show a direct backlight device 11 adopting the internal-external electrode type lamp 1 of FIGS. 15 and 16. The backlight device 11 comprises, on a rear-face side of a liquid crystal panel 12, three optical sheets, i.e., a diffusion sheet 13, lens sheet 14, and DBEF 15. A plurality of lamps 1 are disposed on a rear-face side of these optical sheets. The external electrode 2 is a single sheet-shape electrode common to all the lamps 1 and is grounded. The internal electrodes 3 of all the lamps 1 are connected in parallel to a lighting circuit 4. A reference numeral 16 denotes a reflection plate.

Details of the backlight device 11 shown in FIGS. 17 and 18 including various dimensions are as follows. The liquid crystal panel 12 is a 32-inch panel. Thirty three lamps are arranged in parallel along a vertical direction of the liquid crystal panel 12. Intervals between adjacent lamps 1 (distance between axial lines) “P” are standardized to 21 mm. Further, each lamp 1 is disposed so that the axial line of the bulb 5 extends parallel to the liquid crystal panel 12 and the optical sheets. The bulb 5 of the lamp 1 is 375 mm in length, 3 mm in outer diameter, and 2 mm in inner diameter. The composition of the gas filled in the bulbs 5 is 100% xenon with a gas pressure of 16 kPa. The distance “D” from each bulb 5 to the external electrode 2 is standardized to 5 mm.

FIGS. 19A and 19B are photographs taken from a front direction indicated by an arrow “A” in FIG. 17 (with the liquid crystal panel 12 removed) when the lighting circuit 4 applies a square-waveform driving voltage (117 W) of ±1.2 kV (amplitude 2.4 kV) at frequency 20 kHz.

In FIG. 19A, in place of the three optical sheets, a low-diffusivity acrylic diffusion plate is put into place. On the other hand, in FIG. 19B, all the optical sheets (diffusion sheet 13, lens sheet 14, and DBEF 15) are used.

As shown in FIG. 19A, dark and light areas occur irregularly. Brightness variation among the lamps 1 and non-regularity of such brightness variation can be observed. Further, as shown in FIG. 19B, even when all optical sheets are used, the effect of irregular variation in brightness among the lamps 1 causes non-uniformity in brightness. This non-uniformity in brightness results in non-uniformity in brightness of images displayed on the liquid crystal panel 12.

As discussed above, the direct backlight device using the internal-external type lamps having the gap between the bulbs and the external electrode can not achieve adequate brightness uniformity when the intervals between adjacent lamps are certain level of narrow, that is, when the lamps are arranged densely at certain level. Specifically, there is a conspicuous degradation in brightness uniformity when the bulb inner diameters are approximately from 2 to 3 mm and the interval between adjacent bulbs is 40 mm or less. On the other hand, when the intervals between adjacent lamps are certain level of wide, that is, when the lamps are arranged sparsely at certain level, although the brightness uniformity is improved, efficient brightness can not be obtained. Further, increasing the distance from the liquid crystal panel to the lamps contributes improvement of the brightness uniformity but increases thickness of the backlight device, which conflicts demands for thin-shape. The problem of inefficient brightness uniformity similarly arises regarding other illumination devices than the backlight device as long as that the internal-external lamps with the gap between the bulb and the external electrode are arranged closely at certain level.

International Publication No. WO2005/022586

### DISCLOSURE OF INVENTION

### Problem to be Solved by the Invention

An object of the present invention is to achieve fine brightness uniformity with maintaining efficient brightness in an illumination device having plurality of internal-external electrode type lamps or light source devices with a gap between a bulb and an external electrode.

The present invention provides an illumination device comprising, a plurality of bulbs made of a dielectric material, respectively enclosing a discharge medium containing a rare gas, and arranged so that respective axial lines thereof extend along the same direction, a plurality of internal electrodes respectively arranged inside each of the bulbs and connected in parallel to a lighting circuit for outputting an AC driving current, an external electrode arranged outside each of the bulbs with an gap and grounded, and a holder for holding the bulbs so that distances between the bulbs and the external electrode are regularly varied seen from a direction of the axial line.

Application of the AC diving voltage from lighting circuit between the internal electrode and external electrode causes a dielectric barrier discharge, resulting in that the rare gas is plasmanized to emit light. Because the distances between the bulbs and the external electrode are regularly varied seen from the bulb axial lines, high level of brightness uniformity can be achieved with maintaining relatively dense intervals between the bulbs and minimized thickness (in case of a backlight device for a liquid crystal display, total thickness including those of optical films), compared with a case in which the distances between bulbs and external electrode are constant.

For instance, the bulbs include first bulbs the distance from each of which to the external electrode is a first distance, and second bulbs the distance from each of which from the external electrode is a second distance shorter than the first distance.

Specifically, the first bulbs and the second bulbs are arranged in alternation.

Alternatively, first bulb groups consisting of a plurality of the first bulbs and second bulb groups consisting of a plurality of the second bulbs are arranged in alternation

The plurality of bulbs are arranged on a regular polygonal line or a regular curved line seen from the direction of the axial lines of the bulbs.

The distance between each of the bulbs and the external electrode is greater than a minimum distance defined by the following equation.

$$XL 1 = \frac{V}{E 0} - \frac{ɛ1}{ɛ2} \times X 2$$

X1L: minimum distance
E0: dielectric breakdown electric field intensity of atmospheric gas
V: input voltage
ε1: relative permittivity of air gap
ε2: relative permittivity of a bulb wall
X2: thickness of bulb wall.

By setting the distance between bulbs and external electrode to the value larger than this minimum distance, dielectric breakdown of the atmospheric gas outside the bulbs can be reliably prevented.

This invention is particularly advantageous when an inner diameter of the bulb is approximately between 2 to 3 mm, and an interval between the bulbs is between ½ of an outer diameter of the bulb and 40 mm.

This invention can for example be applied to a backlight device of a liquid crystal display device. In this case, at least one optical sheet is arranged on an opposite side to the external electrode with respect to the bulbs so as to be opposed to the plurality of light source devices and a liquid crystal panel is arranged so as to be opposed to a front-face side of the optical sheet.

### Effect of the Invention

Because the distances between the bulbs and the external electrode are regularly varied seen from the bulb axial lines, high level of brightness uniformity can be achieved with maintaining relatively close intervals between the bulbs and the minimized thickness.

### BRIEF DESCRIPTION OF DRAWINGS

FIG. 1 is a schematic cross-sectional view of a liquid crystal display device comprising a backlight device according to a first embodiment of the present invention;

FIG. 2 is a partial enlarged view of FIG. 1;

FIG. 3 is a cross-sectional view along a line in FIG. 1;

FIG. 4 is a cross-sectional view along a line IV-IV in FIG. 1;

FIG. 5A is a photograph showing a lighting status of the backlight device of the first embodiment (captured using only an acrylic diffusion sheet);

FIG. 5B is a photograph showing the lighting status of the backlight device of the first embodiment (captured using three optical sheets);

FIG. 6 is a graph showing the distribution of relative brightness in a horizontal direction;

FIG. 7 is a graph showing the distribution of relative brightness in a vertical direction;

FIG. 8 is a graph showing the relation between bulb interval and the power per lamp;

FIG. 9 is a schematic equivalent circuit diagram from a discharge space to an outer electrode;

FIG. 10 is a cross-sectional view showing a backlight device according to a second embodiment of the invention;

FIG. 11 is a cross-sectional view showing a backlight device according to a third embodiment of the invention;

FIG. 12 is a cross-sectional view showing a backlight device according to a fourth embodiment of the invention;

FIG. 13 is a cross-sectional view showing a backlight device according to a fifth embodiment of the invention;

FIG. 14 is a cross-sectional view showing a backlight device according to a sixth embodiment of the invention;

FIG. 15 is a schematic cross-sectional view of an internal-external electrode type dielectric discharge lamp;

FIG. 16 is a cross-section along line XV-XV in FIG. 15;

FIG. 17 is a schematic cross-sectional view of a liquid crystal display device comprising a conventional backlight device;

FIG. 18 is a partial enlarged view of FIG. 17;

FIG. 19A is a photograph showing a lighting status of the conventional backlight device (captured using only an acrylic diffusion sheet); and,

FIG. 19B is a photograph showing the lighting status of the conventional backlight device (captured using three optical sheets).

### DESCRIPTION OF REFERENCE NUMERALS

21: backlight device

22: liquid crystal display device

23: liquid crystal panel

24: main body

25: cover member

25a: window portion

26: casing

27: diffusion sheet

28: lens sheet

29: DBFE

30: acrylic diffusion sheet

31: dielectric barrier discharge lamp

32: bulb

35: internal electrode

36: external electrode

37: fluorescent layer

38: conductive member

40: lighting circuit

41: gap

42: reflection plate

43A-43C: holding member

43a: supporting bore

45, 46: capacitor

α: axial line

δ: polygonal line

φ: sinusoidal curve

### BEST MODE FOR CARRYING OUT THE INVENTION

Next, embodiments of the present invention are described in detail referring to attached drawings.

### First Embodiment

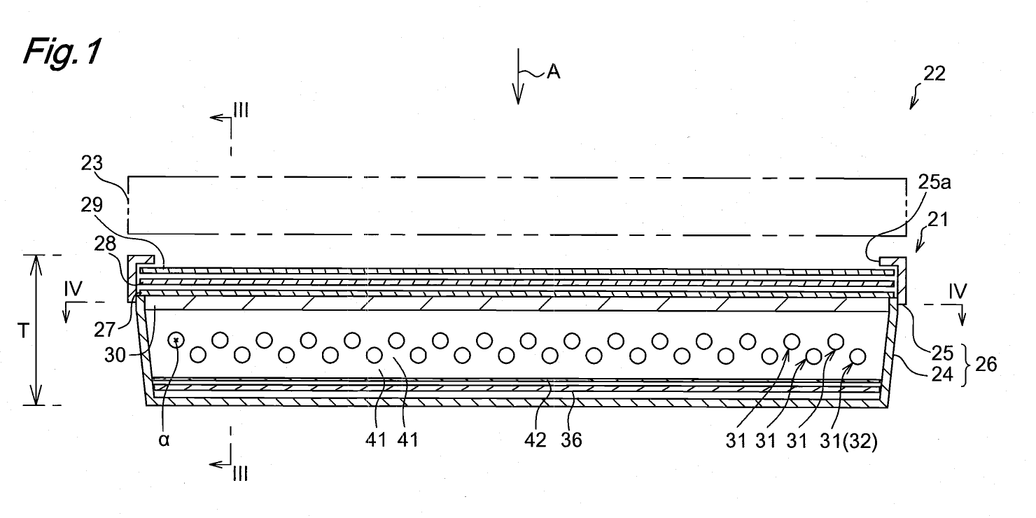

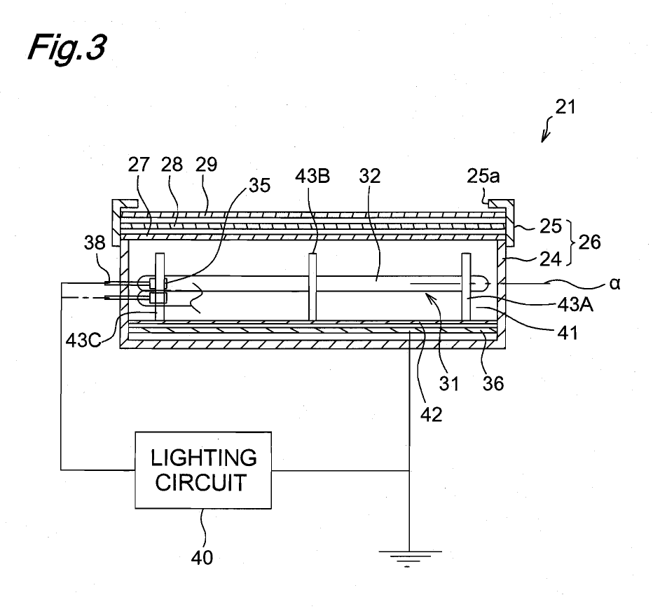

FIG. 1 through 4 show a liquid crystal display device 22 comprising a backlight device 21 according to a first embodiment of an illumination device of the present invention. The backlight device 21 is disposed on a rear-face side of a liquid crystal panel 23 shown in FIG. 1.

The backlight device 21 is provided with a casing 26 consisting of a main body 24 and cover member 25. Accommodated in the casing 26 (near an opening portion of the main body 24) is an acrylic diffusion plate 30. Further, accommodated above the acrylic diffusion sheet 30 in stack manner are three optical sheets, i.e., a diffusion sheet 27, a lens sheet 28, and a DBFE (Dual Brightness Enhancement Film) 29. The cover member 25 is provided with a window portion 25a to expose the optical sheets. A front-face side of the optical sheets is opposed to the liquid crystal panel 23 through the window portion 25a.

In order to efficiently pass light to the liquid crystal panel 23, the diffusion sheet 27 has a construction in which beads serving as spherical lenses are distributed over a sheet, returns light having an angle larger than an aperture angle of the liquid crystal panel 23 to the backlight device 21, so that the diffusion sheet 27 suppresses loss of light in the liquid crystal panel 23. Further, the lens sheet 28 has a construction in which triangular prisms are arranged in are horizontal direction so as to suppress light distribution in a vertical direction to the extent unnecessary for a display device, while leaving unaffected the light distribution in the horizontal direction. Furthermore, the DBEF 29 passes P-polarized component which passes through the liquid crystal panel 23, whereas returns S-polarized component to the backlight device 21, thereby suppressing optical losses in the liquid crystal panel 23. The light reflected by these optical sheets and returned to the backlight device 21 is again used in illumination of the liquid crystal panel 23, resulting in improved light utilization efficiency.

On a rear-face side of the optical sheets within the casing 26, a plurality of internal-external electrode type dielectric barrier discharge lamps (hereafter merely referred to as “lamps”) 31 are arranged in parallel.

The lamp 31 comprise a bulb 32, a discharge medium sealed within the bulb 32, an internal electrode 35, and an external electrode 36. An interior of the lamps 31 serves as a gastight container which functions as a discharge space.

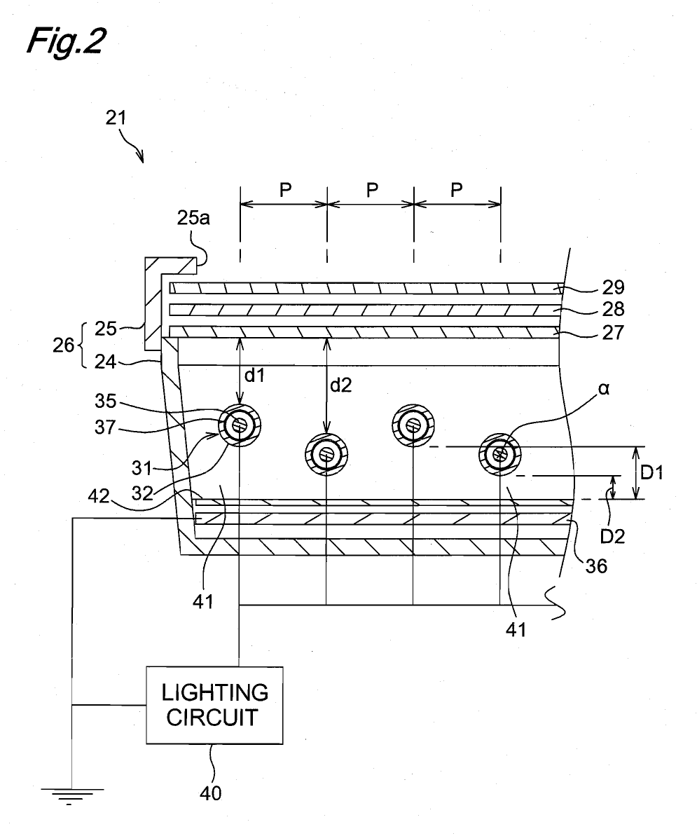

The bulb 32 has a long and thin straight-tube shape extending along its own tube axis or an axial line “α”. Further, the cross-section of the bulb 32 perpendicularly intersecting the axial line “α” has a circular shape. However, the cross-sectional shape of the bulb 32 may be an ellipse, a triangle, a quadrangle, or other shapes. The bulb 32 is made of a dielectric material which essentially has light-transmitting properties, and may for example be made of borosilicate glass. Bulbs 32 may also be made of quartz glass, soda glass, lead glass or other glasses, or made of a organic material such as an acrylic material. As shown only in FIG. 2 in a schematic manner, a fluorescent layer 37 is formed on an inner faces of the bulb 32. The fluorescent layer 37 converts wavelength of light emitted from the discharge medium. By modifying the material of the fluorescent layer 37, light of various wavelengths can be obtained, such as white light, red light, and green light, and red light.

In this embodiment, the discharge medium is xenon (100%), sealed within the bulb 32 at a pressure of approximately 16 kPa. However, as long as containing one or more types of gases which are principally rare gases, the discharge medium may contain mercury. The rare gases other than xenon which may be used for the discharge medium include krypton, argon, and helium.

The internal electrode 35 is arranged at one end within the bulb 32. A distal end of a conductive member 38 having a proximal end provided with the internal electrode 35 is positioned outside of the bulbs 32. The conductive members 38 are electrically connected to a lighting circuit 40. The internal electrodes 35 of all the plurality of lamps 31 are electrically connected in parallel to the lighting circuit 40. The internal electrode 35 is made of, for example, metal such as tungsten or nickel, a surface of which may be covered with a metal oxide layer such as cesium oxide, barium oxide, or strontium oxide, or with a dielectric layer.

The external electrode 36 is a single grounded flat plate common to all the lamps 31 and is arranged separately from an exterior of the bulb 32 by a gap 41. The external electrode 36 is arranged opposite to the acrylic diffusion plate 30 and optical sheets with respect to the bulbs 32 (on the bottom side of the main body 24 of the casing 26). The external electrode 36 is made of a material having conductivity, such as copper, aluminum, stainless steel, or other metal, and may be a transparent conductive material mostly composed of tin oxide or indium oxide. In this embodiment, a reflection plate 42 is arranged between the external electrode 36 and the lamps 31. However, in place of the reflection plate 42 separate from the external electrode 36, the external electrode 36 may itself be made of a material with high reflectivity, or a layer of material with high reflectivity may be formed on a surface of the external electrode 36.

As a result of application of an AC voltage by the lighting circuit 40, dielectric barrier discharge occurs between the internal electrodes 35 of each of the lamps 31 and the external electrode 36, and the discharge medium is excited. The excited discharge medium emits ultraviolet rays when moving back to the ground state. These ultraviolet rays are converted into visible light by the fluorescent layer 37 and then the visible light is emitted from each of the bulbs 32.

A position and an attitude of the bulb 32 of each of the lamps 31 are maintained by holding members (holders) 43A to 43C. Each of the holding members 43A to 43C is provided with supporting bores 43a into which bulbs 32 are inserted and is positioned and fixed onto the casing 26 at a least at a portion. However, the structure of the holding members is not particularly limited as long as the positions and attitudes of the bulbs can be maintained.

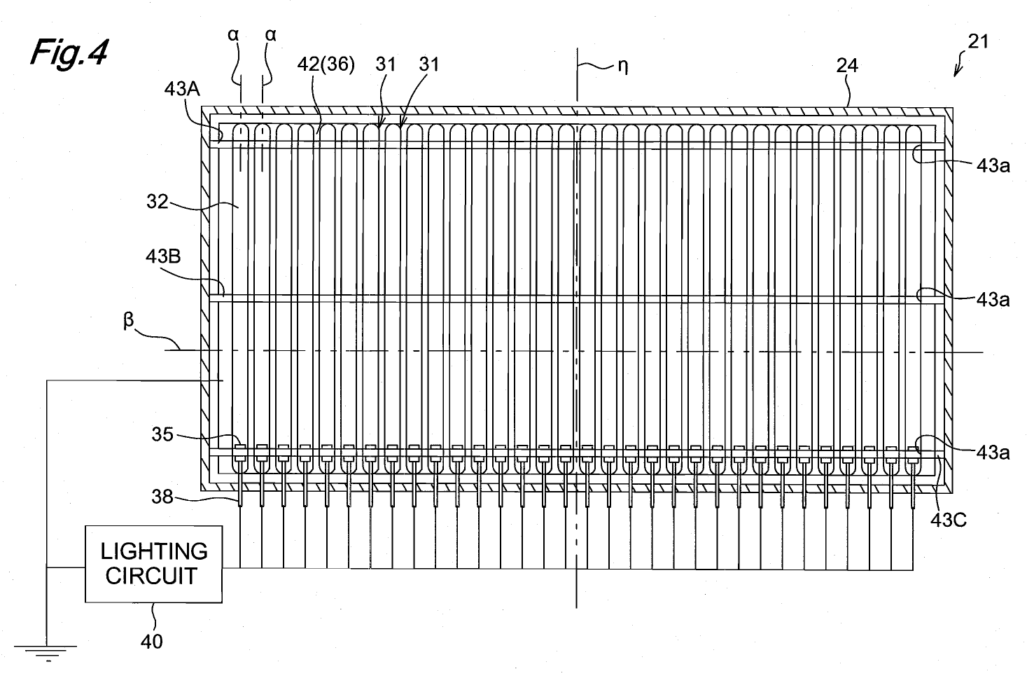

The bulbs 32 of the lamps 31 are arranged so that the axial lines “α” thereof extend along the same direction, that is, so that the axial lines “α” extend in parallel seen from the front direction indicated by the arrow “A” in FIG. 1. Further, as shown in FIG. 4, the bulbs 32 of the lamps 31 are arranged so as to extend in the vertical direction of the liquid crystal panel 23 (shown only in FIG. 1). On the condition that the bulbs are arranged so that the axial lines “α” extend along the same direction, the bulbs 32 may extend not in the vertical direction of the liquid crystal panel 23, but in the horizontal direction.

Referring to FIGS. 1 and 2, distances between the bulbs 32 of the lamps 31 and the external electrode 36 (the minimum distance between an outer peripheral surface of a tube wall of the bulbs 32 and an upper surface of the external electrode 36) regularly vary seen from the direction of the lamp axial lines “α”. Specifically, the bulb 32 the distance from which to the external electrode 36 is a first distance “D1”, and bulbs 32 the distance from which to the external electrode 36 is a second distance “D2” shorter than the first distance “D1” are arranged in alternation. Since the external electrode 36 in this embodiment is the flat plate as described above, by alternating the heights from the upper surface of the external electrode 36 to the bulbs 32, alternating arrangement of the two types of distance “D1” and “D2” is achieved. In other words, by arranging the plurality of bulbs 32 in a so-called zigzag pattern, the alternating placement of the two distances “D1” and “D2” is achieved. The intervals between adjacent lamps 31 (the distances between axial lines “α” of adjacent bulbs 32) “P” are constant.

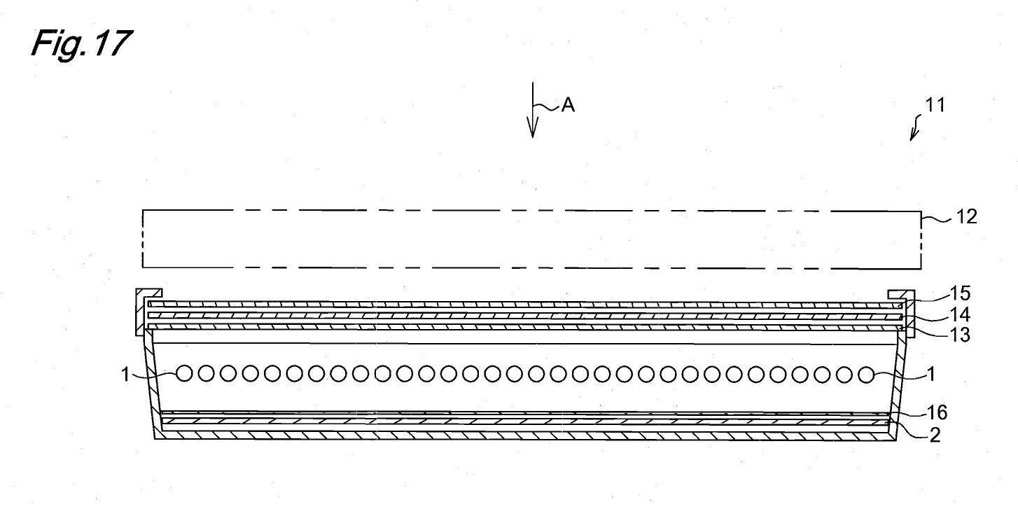

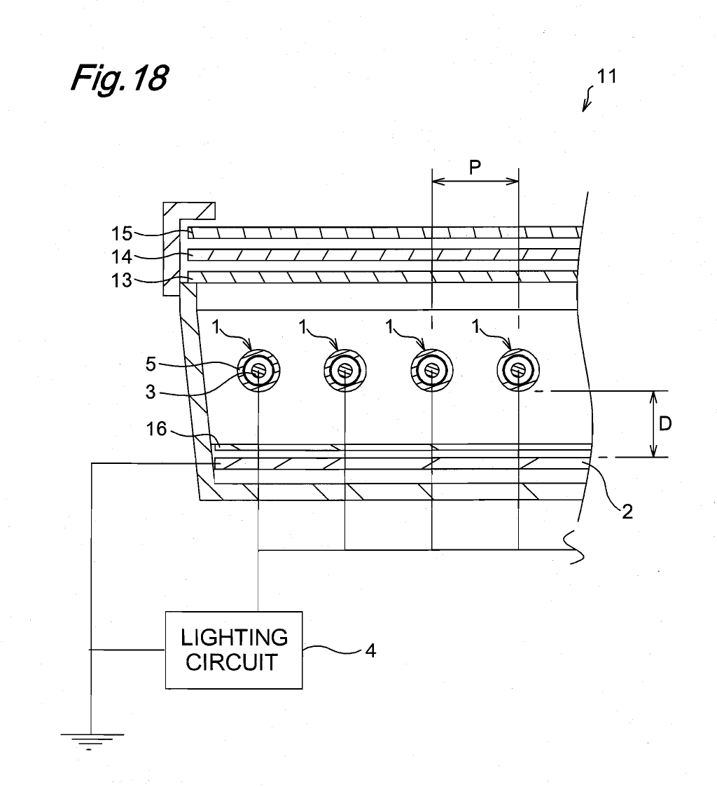

Details of the backlight device 21 in this embodiment including various dimensions are as follows. The liquid crystal panel 23 is a 32-inch panel. The number of lamps 31 is thirty three. The intervals between adjacent lamps “P” are standardized to 21 mm. The bulb 32 of the lamp 31 is 375 mm in length, 3 mm in outer diameter, and 2 mm in inner diameter. Of the two distances from bulbs 32 to the external electrode 36, the longer first distance “D1” is 5 mm and the shorter second distance “D2” is 3 mm. As described above, the discharge medium is 100% xenon and the gas pressure is 16 kPa. Except for that the two distances “D1” and “D2” from the bulbs 32 to the external electrode 36 are alternatively arranged, the details including various dimensions of the backlight device 21 of this embodiment are the same as those of the conventional backlight device 1 shown in FIGS. 17 and 18.

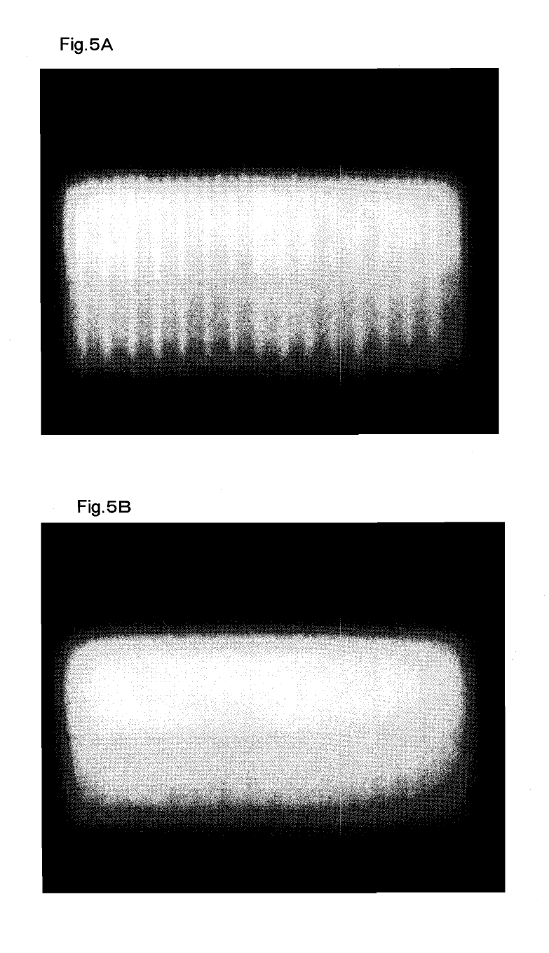

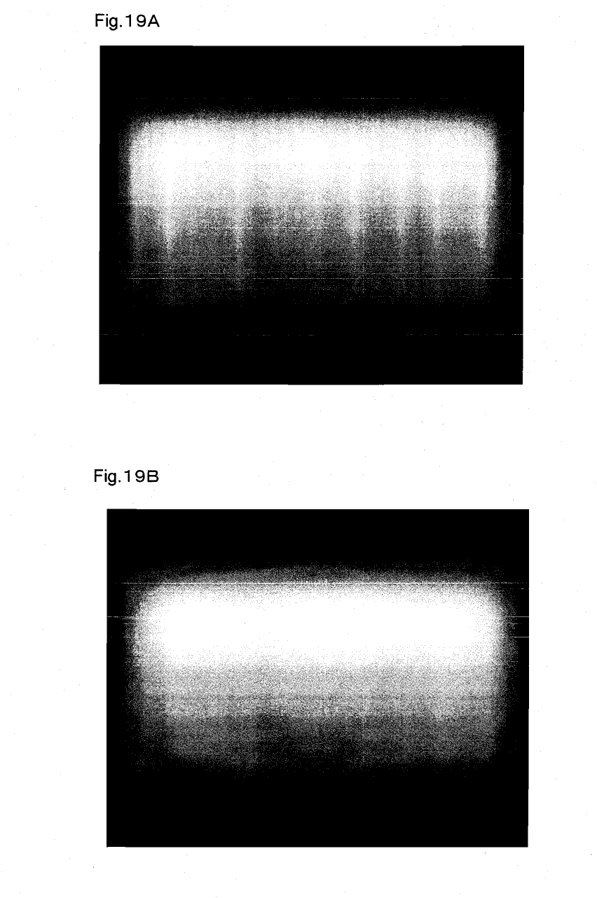

FIGS. 5A and 5B are photographs taken from the front direction indicated by the arrow “A” in FIG. 1 (with the liquid crystal panel 23 removed). The driving voltage applied from the lighting circuit 40 during photograph was the same as that at the time of taking the photographs of the conventional backlight device 11 described above (FIGS. 19A and 19B). That is, a ±1.2 kV (amplitude 2.4 kV) square-waveform driving voltage (117 W) of frequency 20 kHz was applied by the lighting circuit 40.

The condition for FIG. 5A is same as for FIG. 19A; that is, the photograph was taken with a low-diffusivity acrylic diffusion sheet 30 arranged in place of the optical sheets. For the condition of FIGS. 5A and 19A, because diffusivity is low, the brightness of the individual lamps 1 can be seen through the acrylic diffusion sheet. The condition for FIG. 5B is the same as for FIG. 19B, that is, the photo was taken using all the optical sheets (diffusion sheet 27, lens sheet 28, and DBFE 29). For the condition of FIGS. 5B and 19B, because the diffusivity is high, illuminance pattern of the optical sheet by the individual lamps 1 can be seen as a brightness pattern.

As shown in FIG. 5A, bright portions and dark portions occur regularly and in alternation. Specifically, the brightness of lamps 31 with the shorter distance “D2” between the bulb 32 and external electrode 36 is higher than the brightness of lamps 31 with the longer distance “D1” between the bulbs 32 and the external electrode 36, so that the former correspond to the bright portions, and the latter correspond to the dark portions. The two distances “D1” and D2 are arranged in alternation, so that the lamp 1 corresponding to the bright portion is placed at every other position, and the lamp 1 corresponding to the dark portion is placed at every other position. Comparing FIGS. 5A and 19A, it is clear that the bright-dark pattern of brightness of the lamps 31 in this embodiment is greatly regular. As shown in FIG. 5B, the brightness distribution having bright portions and dark portions regularly arranged can be rendered uniform by using all of the optical sheets, so that high brightness uniformity can be achieved. As a result, unevenness in brightness of images displayed on the liquid crystal panel 12 can be greatly reduced. In particular, comparing FIGS. 5B and 19B, it is clear that through alternating arrangement of the two distances “D1” and “D2” in this embodiment, higher brightness uniformity can be obtained.

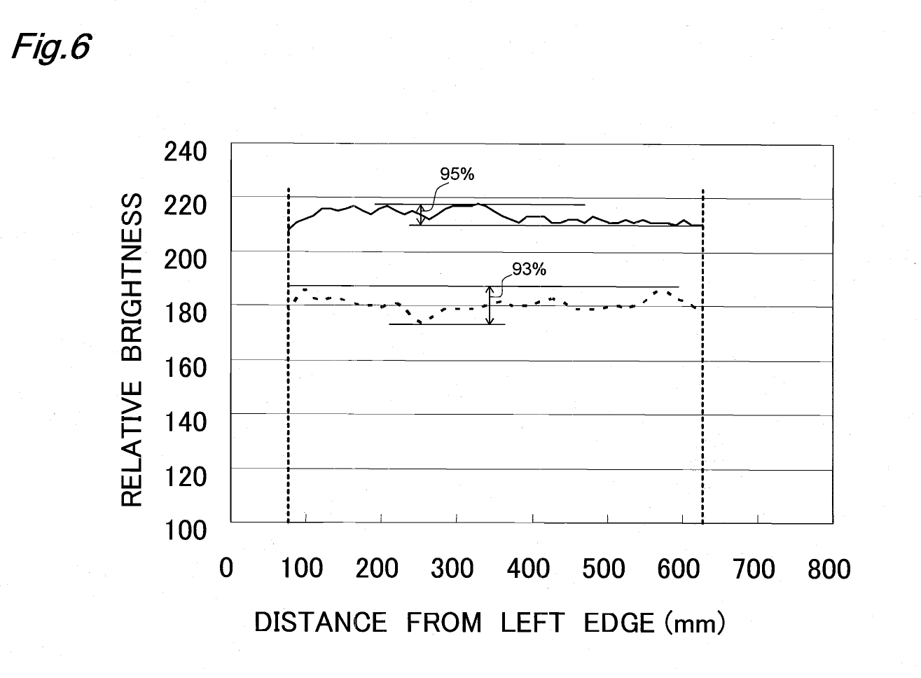

FIG. 6 shows measured values of the brightness distribution in a region of lower ⅓ on the optical sheets (a region below a two-dot chain line “β” in FIG. 4), for the backlight device 21 of this embodiment and the backlight device 11 of FIGS. 16 and 17. A solid line represents the backlight device 21 of this embodiment; a dashed line represents the backlight device 11 of FIGS. 17 and 18. FIG. 6 also shows that the brightness of the backlight device 21 of this embodiment has the repeated bright and dark portions in more regular pattern. Further, a ratio of minimum brightness to maximum brightness over an area excluding the 10% portions at both ends of the screen where the brightness rises is improved from 93% to 95%. Since the irregular bright-dark unevenness is cured, the improvement actually sensed is greater than the improvement numerically expressed.

The reason for the higher brightness uniformity while densely arranged lamps 31 in the backlight device 21 of this embodiment is inferred to be as follows.

Referring to FIGS. 17 and 18, in which the distance between bulbs and external electrode is constant, when the AC voltage is applied across the internal electrodes 3 within each of the bulbs 1 and the external electrode 2 by the lighting circuit 4, the voltage is dividedly applied to two capacitors formed and connected in series between each of the internal electrodes 3 and the external electrode 2. One of these capacitors is formed between the internal electrode 2 and the wall surface of the bulb 5 and has the xenon gas as the dielectric material, whereas the other capacitor is formed between the inner surface of the bulb 5 and the external electrode 2 and has the air in the gap and the bulb wall of the bulb 5 as the dielectric materials. When the voltage applied across the internal electrode 3 and the inner wall of the bulb 5 exceeds a breakdown voltage of the xenon gas sealed within the bulb 5, discharge plasma is generated between the internal electrode 3 and the inner wall of the bulb 5. Positive ions in the discharge plasma collect at the glass surface, whereas electrons are attracted to the opposing external electrode 2 so as to cause opposite polarity. The discharge plasma is initially generated between the internal electrode 3 and at the portion of the inner wall of the bulb 3 closest to the internal electrode 3. When positive ions have accumulated, the electric field is neutralized between the internal electrode 3 and the inner wall of the bulb 3 in this portion, so that discharge plasma moves in sequence to an adjacent portion in which positive ions have not accumulated. As a result, the discharge plasma extends from one end portion at which the internal electrode 3 is positioned within the bulb 5 to the other end portion. Further, when the polarity of the applied voltage is reversed, electrons in the plasma accumulate on the inner wall of the bulb 5 and the external electrode 2 emits electrons. That is, in a dielectric barrier discharge lamp, capacitors are formed across the bulb 5 made of dielectric material and energy is supplied to the plasma through reversing the polarity of the external voltage 5, thereby obtaining ultraviolet irradiation at wavelengths 147 nm and 172 nm due to irradiation of Xenon as the rare gas to cause the fluorescent layer to emit light.

During this process, because charges having same polarity are accumulated in the bulbs 5 of respective lamps 1, interferences of Coulomb forces due to charges occur between respective lamps. This causes tendency where the brightness is higher for the lamp 1 furthest on the outside due to reduced effect of interference, but the closer to a center of the backlight device 11 the lamp 11 is located, the lower the brightness thereof is due to emphasized effect of the interference. Further, due to variation among the lamps 1 in characteristics such as the pressure at which the discharge medium is sealed in the bulbs 1, the amount of impurity gases contained in the discharge medium, the mechanical distance between the bulb 5 and the external electrode 2, variation among the lamps 1 arises in the speed with which the discharge plasma extends from the end of the internal electrode 3 of the bulb 3 to the other end. This variance in the speed with which the discharge plasma is extended affects the interference of Coulomb force due to charges among the lamps, thereby causing differences in the brightness of the lamps 1. The above reasons are inferred to result in that the backlight can not achieve adequate brightness uniformity and shows uneven brightness.

Contrary, according to the present invention, the lamps 31 having the bulbs 32 at the long distance from the external electrode 36 (distance D1) and the lamps 31 having the bulbs 32 at the short distance from the external electrode 36 (distance D2) are arranged in alternation, resulting in that the minimum distance between adjacent bulbs 32 increases compared with the case where the distances between external electrode and bulbs are constant. As a result, interference of Coulomb force due to charges among the lamps is weakened.

Comparing the capacitances of capacitors formed between the inner wall surface of a bulb 32 and the external electrode 36 for both of the lamp 31 having the bulb 32 the distance from which to the external electrode 36 is long (distance “D1”) and the lamp 31 having the bulb 32 the distance from which to the external electrode 36 is short (distance “D2”), the latter has lager capacity than that of the former. Hence, the configuration of this embodiment in which the two distances “D1” and “D2” are alternately arranged is a configuration in which the lamps 31 for which the capacitance of the capacitor formed between the bulb 32 and external electrode 36 is large and the lamps 31 for which the capacitance is small are alternately arranged. In other words, in this embodiment, the lamps 31 with a large input power (distance “D2”) and the lamps 31 with a small input power (distance “D1”) are intentionally arranged in alternation. As a result, the regular bright-dark pattern of the brightness among the lamps due to the regular alternation of capacity and input power becomes larger than the irregular variation in brightness among lamps due to the variance among the lamps 1 in the characteristics such as the sealed pressure of the discharge medium, the impurity gas content in the discharge medium, and the mechanical distance between the bulb 5 and external electrode 2. It may be said that the former brightness variance is absorbed by the latter regular bright-dark pattern of brightness.

When the distances to the optical sheets are compared for lamps 31 with relatively large input power and high brightness having bulbs 32 at the short distance to the external electrode 36 (distance “D2”) and the lamps 31 with relatively small input power and low brightness having bulbs 32 at the long distance to the external electrode 36 (distance “D1”), the distance “d1” for the latter is shorter than the distance “d2” for the former (see FIG. 2). In other words, the relatively bright lamps 31 are positioned further from the optical sheets, and the relatively dark lamps 31 are positioned closer to the optical sheets. The relation between the difference in brightness among the lamps 31 and the distance to the optical sheets functions so as to unify the intensity of light reaching the optical sheets or illuminance with respect to the optical sheets among the lamps, thereby contributing to increase the brightness uniformity at the optical sheets.

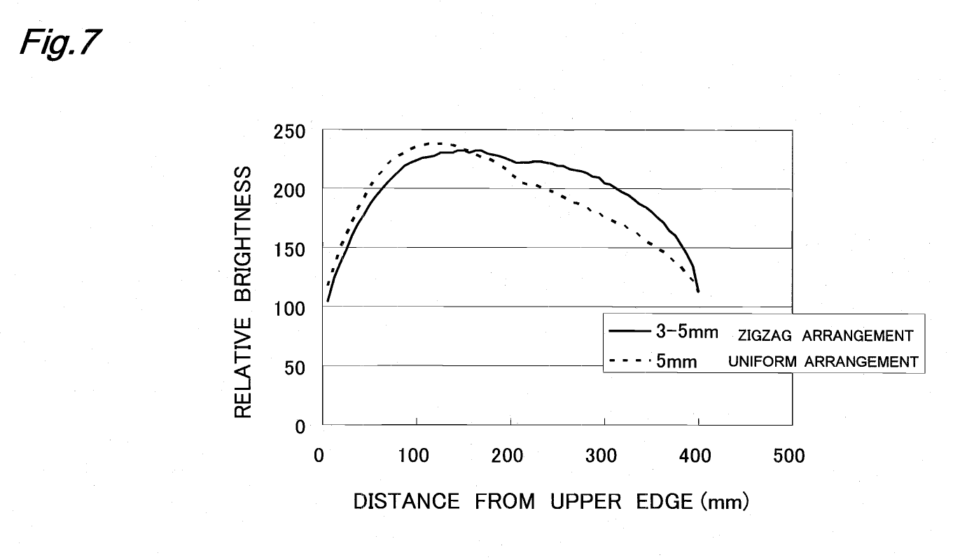

The internal-external electrode type dielectric barrier discharge lamp provided with the gap between the external electrode and the bulb generally has tendency where the larger the distance between the bulb and external electrode is, the better the efficiency is but the further the brightness distribution in the axial line direction worsens, and the smaller the distance between bulb and external electrode is, the lower the efficiency is but the further the axial line-direction brightness distribution improves. In the backlight device 11 of this embodiment, when the distances between the bulbs 32 and the external electrode 36 are set to “D1”=5 mm and “D2”=3 mm, the lamp efficiency is approximately 97% of that when D1=D2=5 mm, so that the lamp efficiency is not greatly reduced. On the other hand, in case that the same voltage of 2 kV is applied, the lamp power is 101.7 W when the distances between the bulbs 32 and external electrode 36 are D1=D2=5 mm, whereas the input power increases to 104.4 W whereas when D1=5 mm and h2=3 mm. Under the later condition, there are advantages of a large input power and improvement of the brightness uniformity in the lamp axial line “α” direction. FIG. 7 shows the brightness distribution in the vertical direction (lamp axial line a direction) of a center portion in a width direction on the optical sheets (see a two-dot chain line “γ” in FIG. 4). A solid line indicates the case of this embodiment (D1=5 mm, D2=3 mm), and a dashed line indicates the case of the configuration shown in FIGS. 17 and 18 (D1=D2=5 mm). Upon comparing the two cases, it is clear that the brightness distribution in the lamp axial line “α” direction is improved in this embodiment.

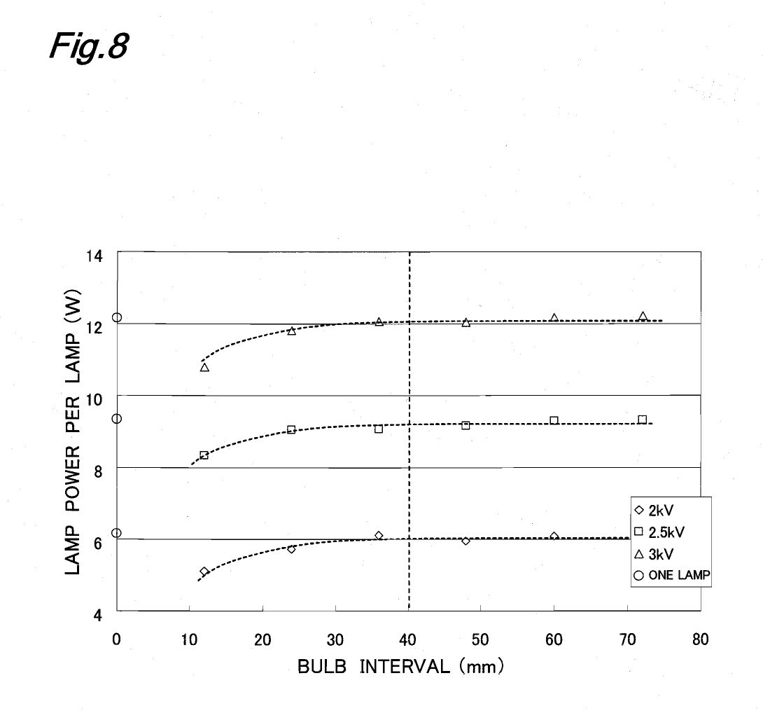

The present invention is especially advantageous when the inner diameter of bulbs 32 is approximately 2 mm or greater and 3 mm or less and the interval “P” between adjacent bulbs 32 is ½ the outer diameter of the bulbs 32 or greater and 40 mm or less. The reason for this is explained below. If the outer diameter of the bulbs 32 is set to 3 mm and the distances D1, D2 between the bulbs 32 and the external electrode 36 are set to 5 mm in the backlight device 21 of the bulb 32, a square wave of amplitude 2 kV or higher necessary to be applied across the internal electrodes 35 and external electrode 36 for obtaining light emission over the entire 400 mm length of the lamps. FIG. 8 shows the interval “P” between the bulbs 32 and the lamp power per lamp. As shown in FIG. 8, when the interval “P” between the bulbs 32 is reduced to approximately 40 mm (and in particular to 30 mm or less), the decline in the power per lamp becomes conspicuous. This is inferred to arise due to the fact that when the interval “P” between bulbs 32 is approximately 40 mm or less, the Coulomb force interference between charges having the same polarity and accumulated in the inner walls of the bulbs 32 becomes conspicuous, so that accumulation of charges beyond a certain extent is limited, and moreover the smaller the interval “P”, the more the effect of interference is intensified. When the interval “P” between bulbs 32 is approximately 40 mm or less, irregular patterns in the brightness distribution of light passed through the optical sheets become conspicuous as explained above. This is attributed to the Coulomb force interference between charges having same polarity. The more the distance from the lamps 31 to the optical sheets is increased, the more irregular patterns in the brightness distribution are alleviated, so that the brightness uniformity is enhanced. However, increases in the distance from the lamps 31 to the optical sheets directly causes an increase in a thickness “T” of the backlight device 21 (see FIG. 1), which conflicts demands for thin-shape which is one of the most important demands regarding the liquid crystal display devices 22. On the other hand, in this embodiment, the alternating arrangement of the lamps having two distances “D1”, “D2” between the bulbs 32 and external electrode 36 eliminates the irregular patterns in the brightness distribution to enhance the brightness uniformity without increasing the thickness “T” of the backlight device 21.

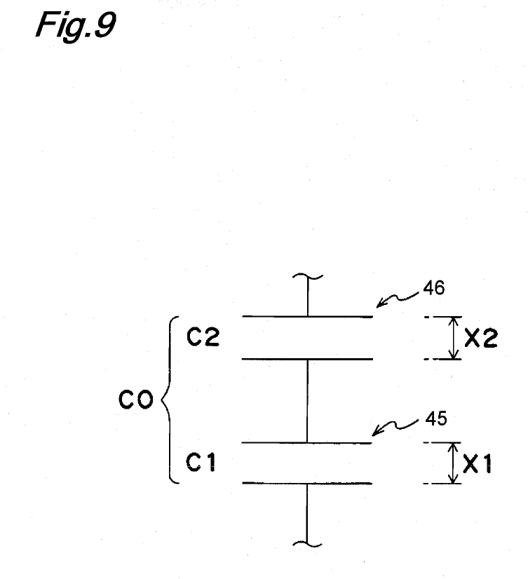

Next, quantitative settings of the distance for the gaps 41 between external electrode 36 and bulbs 32 are explained. Referring to FIG. 9, the gap 41 and a solid dielectric layer including the bulb wall of the bulb 32 exist between the external electrode 36 and the discharge space. Further, the gap 41 and the solid dielectric layer can be regarded as equivalent to capacitors 45 and 46 connected in series.

From the definition of a capacitor, the capacitances C1, C2 of the respective capacitors 45, 46 are expressed by equation (1) below.

C1=S·ε1/X1

C2=S·ε2/X2 (1)

Here, “ε1” is relative permittivity of the gap 41, “ε2” is relative permittivity of the solid dielectric layer, “X”1 is the distance across the gap 41, and “X2” is the distance across of the dielectric layer or thickness thereof.

Further, the following relation (2) is obtained for charge “Q” accumulated in the capacitors 45, 46.

Q=C0·V=C1·V1=C2·V2 (2)

Here, “C1” and “C2” are the capacitances of the capacitors 45, 46, “C0” is combined capacitance of the capacitors 45, 46, “V”1 is voltage applied across the gap 41, “V”2 is voltage applied across the solid dielectric layer, and “V” is voltage applied across the discharge space and external electrode 36.

Further, the following equations (3) through (5) are obtained among the voltage “V1” applied across the gap 41, the voltage “V2” applied across the dielectric layer, the voltage “V” applied across the discharge space and external electrode 36, electric field “E” in the gap 41, and electric field “E” in the solid dielectric layer.

V=V1+V2 (3)

E=V1/X1 (4)

E′=V2/X2 (5)

From equations (2) through (5), the following equation (6) is obtained.

E=V1/X1=C2·V/(C1+C2)·X1 (6)

By substituting the above equation (1) into equation (6), the following equation (7) is obtained for the electric field “E” in the gap 41.

E=ε2·V/(ε2·X1+ε1·X2) (7)

In this embodiment the gap 41 is filled with air which has a relative permittivity of 1, so that the following equation (7′) is particularly obtained.

E=ε2·V/(ε2·X1+X2) (7)′

If the dielectric breakdown field for the gap 41 is denoted by “E0”, then in order to prevent dielectric breakdown in the gap 41, the following equation (8) is necessary to be satisfied.

E0>E (8)

By substituting the equation (7) into the equation (8), the following inequality (9) is obtained.

X1>V/E0−ε1/ε2×X2 (9)

Further, when the gap 41 is the air (ε1=1), the following inequality (9)′ is obtained.

X1>V/E0−X2/ε2 (9)′

Therefore, in order to prevent dielectric breakdown in the gap 41, the distance X1 of the gap 26 necessary to be set larger than the shortest distance “X1 L” defined by equation (10) below.

X1L=V/E0−ε1/ε2×X2 (10)

In particular, when the gap 26 is filled with air, the shortest distance “X1L” is defined by the following equation (10)′.

X1L=V/E0=X2/ε2 (10)′

If the distance “X1” of the gap 41 is set to be larger than the minimum distance “X1L”, then dielectric breakdown of the atmospheric gas filling the gap 41 can be prevented, and damage to peripheral members by gas molecules ionized by dielectric breakdown can be prevented. In this embodiment, the atmospheric gas is air and damage to peripheral members by ozone occurring due to dielectric breakdown can be prevented.

The minimum distance for the distance “X1” of the gap 41 is obtained based on the condition that it be possible to ignite the light source device by a reasonable input power. In other words, if the distance is excessively large, the input power required to ignite the light source device must also be set excessively high, which is unrealistic.

In addition to the above conditions for the maximum and minimum values, the distance between the external electrode 36 and the bulbs 32 (gap distance “X1”) is also determined taking into account the above-described lamp efficiency and the brightness uniformity in the axial line direction. In the case of a dielectric barrier discharge lamp 3 with a lamp length of 250 mm or greater, into which xenon gas is sealed at a pressure of approximately 5 to 40 kPa, the effective range for the distance between external electrode 36 and bulb 32, taking the lamp efficiency into consideration, is from 2 mm to 7 mm. Therefore, the two distances “D1”, “D2” may be set in this range with a difference therebetween of 0.5 mm or greater.

### Second Embodiment

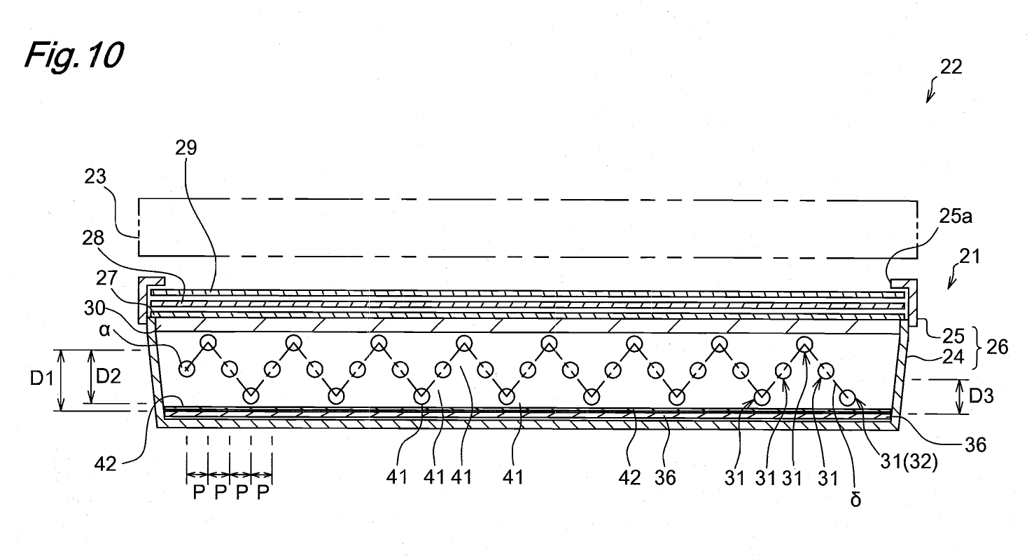

FIG. 10 shows the backlight device 21 of a second embodiment of the present invention. In this first embodiment, the bulbs 32 are arranged on a regular polygonal line “δ” seen from the direction of the axial lines “α” of the bulbs 32. Specifically, the backlight device 21 are provided with, in addition to the bulbs 32 the distance from which to the external electrode 36 is the first distance “D1” and the bulbs 32 the distance from which to the external electrode 36 is the second distance “D2” shorter than the first distance “D1”, bulbs 32 arranged intermediately between the bulbs 32 at the distance “D1” and the bulbs 32 at the distance “D2” and having a distance “D3”. Seen from the direction of the axial lines “α”, the bulbs 32 are arranged with the fixed interval “P” so that the distances “D1”, “D3”, “D2”, and “D3” are repeated in this order from the left side to the right side in FIG. 10.

Since other configurations and functions of the second embodiment are similar to those of the first embodiment, descriptions are omitted with assigning the same symbols to the same elements.

### Third Embodiment

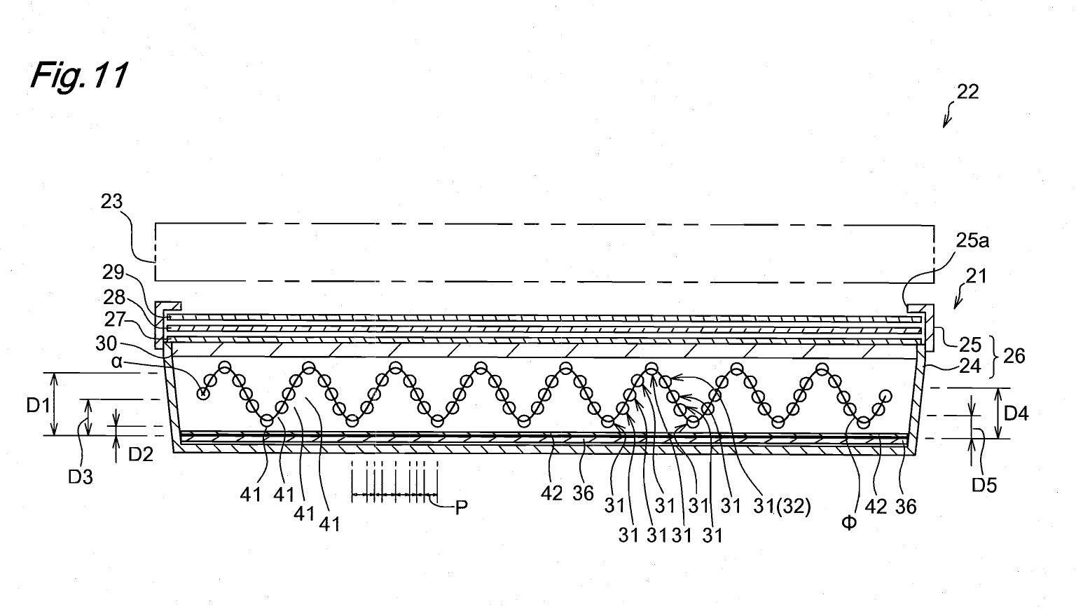

FIG. 11 shows the backlight device 21 of a third embodiment of the present invention. In the third embodiment, bulbs 32 are arranged on a sinusoidal curve “φ” seen from the direction of the axial lines “α” of the bulbs 32. Specifically, the backlight device 21 are provided with, in addition to the bulbs 32 the distance from which to the external electrode 36 is the first distance “D1” and the bulbs 32 the distance from which to the external electrode 36 is the second distance “D2” shorter than the first distance “D1”, bulbs 32 arranged intermediately between the bulbs 32 at distances “D1” and “D2 (at distance “D3”), bulbs 32 arranged intermediately between the bulbs 32 at distances “D1” and “D3” (at distance “D4”), and bulbs 32 arranged intermediately between bulbs 32 at distances “D2” and “D3” (at distance “D5”). Seen from the direction of the axial line “α”, the bulbs are arranged with the fixed interval so that the distances “D1”, “D4”, “D3”, “D5”, “D2”, “D5”, “D3”, “D4”, and “D1” are repeated in this order from the left side to the right side in FIG. 11.

Since other configurations and functions of the third embodiment are similar to those of the first embodiment, descriptions are omitted with assigning the same symbols to the same elements. The bulbs 32 may be arranged on, not limiting to the sinusoidal curve “φ”, other curve having a regular pattern seen from the direction of the axial line “α”.

### Fourth Embodiment

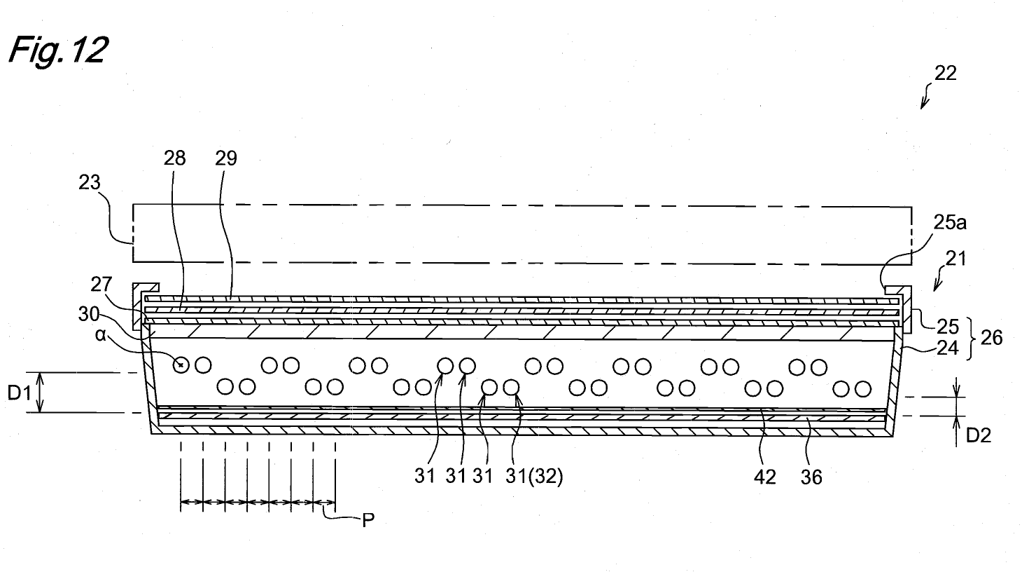

FIG. 12 shows the backlight device 21 of a fourth embodiment of the present invention. The backlight device 21 of the fourth embodiment is similar to the first embodiment in that the distances from the bulbs 32 to the external electrode 36 include two kind of distances “D1” and “D2”. However, in this embodiment, two bulbs 32 having same distance seen from the axial line “α” form a set (bulb group), and these bulb groups are arranged in alternation. Specifically, seen from the direction of the axial lines “α”, bulbs 32 are arranged so as to repeat the distances “D1”, “D1”, “D2”, “D2”, “D1, and “D1” in this order.

Since other configurations and functions of the fourth embodiment are similar to those of the first embodiment, descriptions are omitted with assigning the same symbols to the same elements. Three or more bulbs 32 at the same distance from the external electrode 36 seen from the direction of the axial line “α” may form one set, and these sets may be arranged in alternation.

### Fifth Embodiment

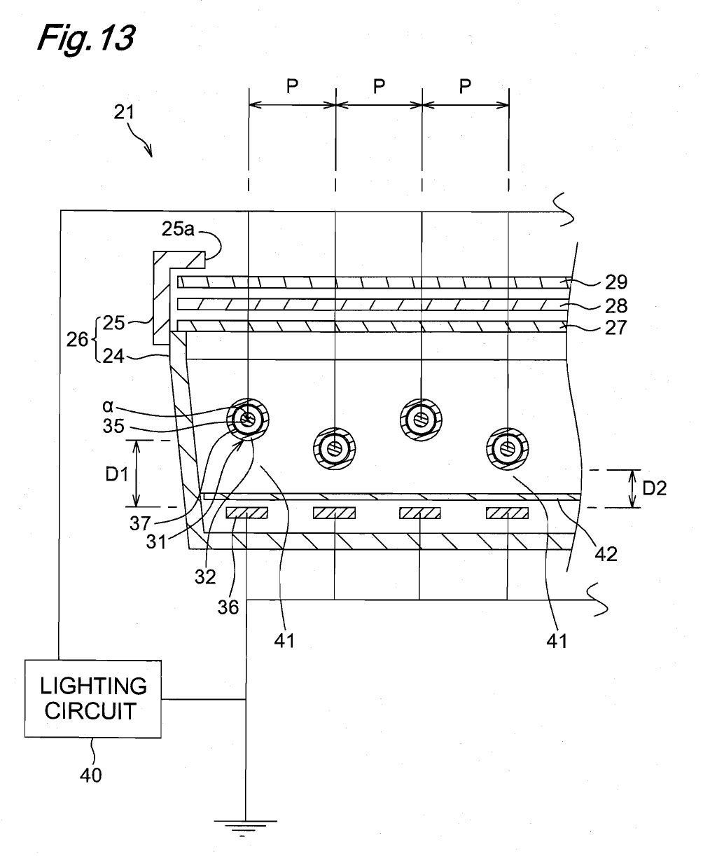

FIG. 13 shows the backlight device 21 of a fifth embodiment of the present invention. Although the external electrode 36 is a single planar plate common to all of the lamps 31, but in this embodiment the external electrodes 36 are long, thin strip shapes provided separately for each lamp 31. All the external electrodes 36 are electrically connected in parallel and grounded. Thus, on the condition that the external electrodes 36 are electrically interconnected, they may be a single element or separated elements provided for respective lamps.

Since other configurations and functions of the fifth embodiment are similar to those of the first embodiment, descriptions are omitted with assigning the same symbols to the same elements.

### Sixth Embodiment

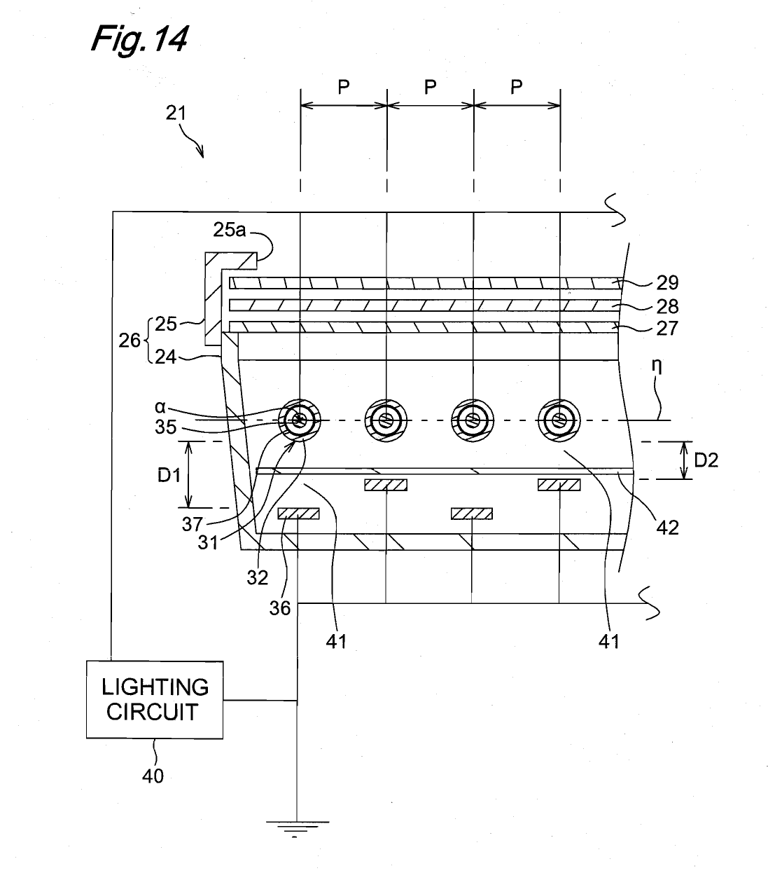

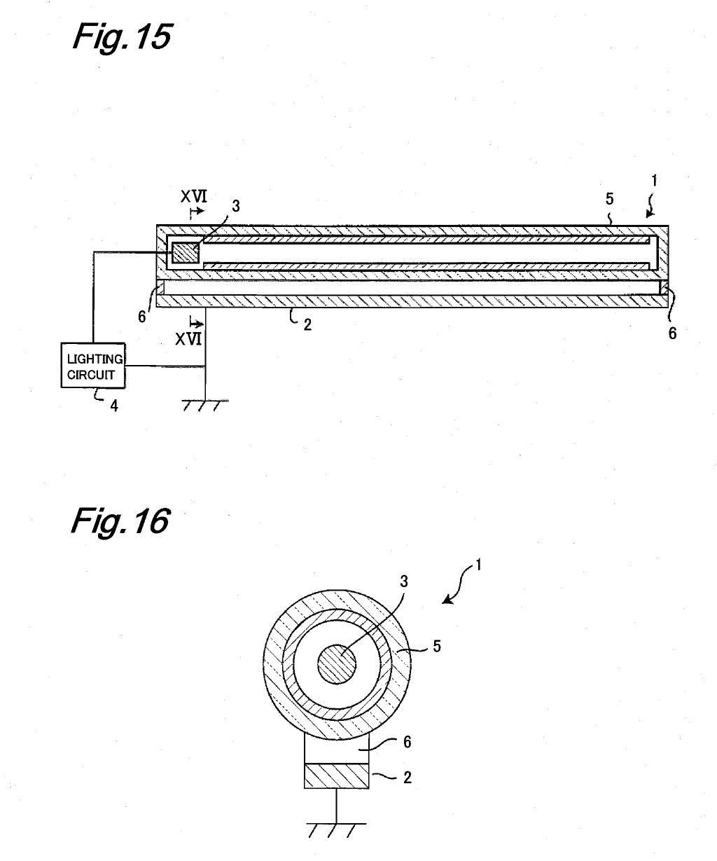

FIG. 14 shows a liquid crystal display device comprising the backlight device 21 of the fifth embodiment. Similarly to the fifth embodiment, separate external electrodes 36 are provided for each of the lamps 31. Seen from the direction of the axial line “α”, the bulbs 32 of all the lamps 31 are arranged on a single straight line “η”. On the other hand, height positions of the external electrodes 36 in FIG. 14 are changed in alternation, thereby achieving the alternating placement of the two distances “D1”, “D2”.

Since other configurations and functions of the sixth embodiment are similar to those of the first embodiment, descriptions are omitted with assigning the same symbols to the same elements.

The present invention is not limited to the above-described embodiments, and various modifications are possible as listed below for example.

Application of the present invention is not limited to the backlight device of the liquid crystal display device and includes such illumination device such as an illumination device for illuminating an original in apparatuses including a facsimile machine and copier, or general illumination device.

The internal-external electrode type discharge barrier dielectric lamp may have internal electrodes positioned not only at one end but at both ends within the bulb.

Although the present invention is fully described with respect to preferred embodiments referring to the attached drawings, various modifications and alterations will be apparent to persons those who skilled in the art. Such modifications and alterations are should be understood as being included within the scope of the present invention defined by attached claims as long as not departing from the scope.

The disclosures of the specification, drawings, and claims of Japanese Patent Application No. 2006-307796 filed on Nov. 14, 2006 are incorporated herein by reference.

1. An illumination device, comprising:
a plurality of bulbs made of a dielectric material, respectively enclosing a discharge medium containing a rare gas, and arranged so that respective axial lines thereof extend along the same direction;
a plurality of internal electrodes respectively arranged inside each of the bulbs and connected in parallel to a lighting circuit for outputting an AC driving voltage;
an external electrode arranged outside each of the bulbs with an gap and grounded; and
a holder for holding the bulbs so that distances between the bulbs and the external electrode are regularly varied seen from a direction of the axial line.

2. An illumination device according to claim 1, wherein the bulbs include first bulbs the distance from each of which to the external electrode is a first distance, and second bulbs the distance from each of which from the external electrode is a second distance shorter than the first distance.

3. An illumination device according to claim 2, wherein the first bulbs and the second bulbs are arranged in alternation.

4. An illumination device according to claim 2, wherein first bulb groups consisting of a plurality of the first bulbs and second bulb groups consisting of a plurality of the second bulbs are arranged in alternation.

5. An illumination device according to claim 1, wherein the plurality of bulbs are arranged on a regular polygonal line seen from the direction of the axial line of the bulb.

6. An illumination device according to claim 1, wherein the plurality of bulbs are arranged on a regular curved line seen from the direction of the axial lines of the bulbs.

7. A light source device, comprising the illumination device according to claim 1, wherein the distance between each of the bulbs and the external electrode is greater than a minimum distance defined by the following equation:
$$XL 1 = \frac{V}{E 0} - \frac{ɛ 1}{ɛ 2} \times X 2$$
X1L: minimum distance
E0: dielectric breakdown electric field intensity of atmospheric gas
V : input voltage
ε1: relative permittivity of air gap
ε2: relative permittivity of a bulb wall
X2: thickness of bulb wall.

8. An illumination device according to claim 1, wherein an inner diameter of the bulb is approximately between 2 to 3 mm and an interval between the bulbs is between ½ of an outer diameter of the bulb and 40 mm.

9. An illumination device according to claim 1, further comprising at least one optical sheet arranged on an opposite side to the external electrode with respect to the bulbs.

10. A liquid crystal display device, comprising:
the illumination device according to claim 9; and
a liquid crystal panel arranged so as to be opposed to a front-face side of the optical sheets.
